(19) United States
(12) Patent Application Publication
(10) Pub. No.: US 2006/0028723 A1
(43) Pub. Date: Feb. 9, 2006

(54) Method and structure of a polarizer with uniform property of optics

(75) Inventors: Jyang-Hong Chen, Tao-Yuan (TW); Chien-Chiu Peng, Tao-Yuan (TW); Yu-Chung Liao, Tao-Yuan (TW); Hung-Chi Chen, Tao-Yuan (TW)

Correspondence Address: BIRCH STEWART KOLASCH & BIRCH, PO BOX 747, FALLS CHURCH, VA, 22040-0747, US

(73) Assignee: Optimax Technology Corporation

(21) Appl. No.: 11/100,529

(22) Filed: Apr. 7, 2005

(30) Foreign Application Priority Data
Aug. 4, 2004 (TW) 093109739

(51) Int. Cl. G02B 27/28; G02B 5/30

(52) U.S. Cl. 359/485

(57) ABSTRACT

A method and structure of a polarizer with the uniform properties of optics is provided in the present invention that forms a diffusing adhesive layer above the polarizer layer. By having a different refraction coefficient in a plurality of nano particles and a resin so the incident light is uniformly dispersed and spread. Hence, the contrast of a display is improved, further, the viewable angle is enhanced.

### BACKGROUND OF THE INVENTION

1. Field of the Invention

The present invention relates to a method of forming a polarizer and the structure thereof, and more particularly relates to forming a diffusing adhesive layer on a polarizing layer of the polarizer to provide the display panel with an enlarging contrast value and viewable angle.

2. Description of the Prior Art

A polarizer, also named polarizing film, is utilized to control the polarizing direction of the incident light and allow the polarized light pass through. Hence, the polarizer can be applied in a LCD display panel to increase the contrast value of black and white and in other applications such as the sunglasses, the light filter of photographic equipment, the goggle and the head light in car with anti-glare function, light adjuster, polarizing microscope and glasses for specific medical purposes.

According to the optical characteristics and uses, the Polarizer is classified into a normal type, a high contrast type and a super high contrast type. The normal type is suitable for use in the twist nematic (TN) LCD display panels such as in a calculator and a watch; the high contrast type is usually applied in the super twist nematic (STN) LCD panels such as in a cellular telephone and in a PDA; and the super high contrast type is utilized in the thin film transistor (TFT) LCD display panels such as in a notebook screen and a desktop monitor.

In addition, according to the ingredient, the polarizer is classified into an Iodine-type and a dye-type. It is because that the iodine ions such as I₃⁻ and I₅⁻ and the dichromic dye molecule could be adsorbed and aligned orderly in a high polymer film to make the polarizer having a polarization property. Hence, portion of the incident light, parallel to the alignment direction of the iodine ions or the dichromic dye molecules will being absorbed, and other portion, vertical to the alignment direction will passing through.

FIG. 1A is a section view of the structure of a conventional polarizer. Firstly, the polarizer is composed of a polarizing layer 101, which is formed by a polyvinyl alcohol (PVA) film (not shown in FIG. 1A) and two triacetyl-cellulose (TAC) films (not shown in FIG. 1A) respectively formed on both sides of the polyvinyl alcohol film. The TAC film comprises a plurality of materials with dichromatism, such as Iodine ions (I₃⁻ and I₅⁻) or dye molecules.

Then, a semi-transparent layer 103 is formed below the polarizing layer 101. The semi-transparent layer 103 comprises a plurality of semi-transparent particles 104 scattering over the semi-transparent layer 103. The semi-transparent layer 103 adheres to the surface below the polarizing layer 101 by a adhesive 103′. The material of semi-transparent particles 104 can be mica. Moreover, a release film 107 is formed above the polarizing layer 101 to provide a protection. The release film 107 adheres to the surface above the polarizing layer 101 by a second adhesive 107′. Besides, a substrate 105 is formed below the semi-transparent layer 103 and adheres to the semi-transparent layer 103 by a third adhesive 105′. The LCD cannot radiate light itself, hence the LCD must be equipped with external or internal light source to emitting light 109.

Referring to FIG. 1B, the semi-transparent particles 104 within the semi-transparent layer 103 are equipped with various dimensions and distributed randomly, and the quantity of semi-transparent particles 104 with larger or smaller dimension is less than that with regular dimension. Referring to FIG. 1C, when the light 109 penetrates the semi-transparent layer 103 and encounters larger or lots of semi-transparent particles 104 (such as area 109E, 109D, and 109C), the penetrating rate and the brightness (109E, 109D, and 109C) are decreased; similarly, when the light 109 encounters smaller or less semi-transparent particles 104, the penetrating rate and the brightness (109B and 109A) are increased. When the light 109 is emitted from the light source and then penetrates the polarizer, the brightness distribution is not uniform. So the brightness contrast and the viewable angle of a device are bad. Obviously the device shows more yellow light and background color becomes a darker yellow. Therefore the displayed words and contrast of background are of a poor quality.

To solve the problems of a conventional polarizer, a method for improving brightness contrast and the viewable angle of a device has to be created.

### SUMMARY OF THE INVENTION

A conventional polarizer has many problems. Therefore the present invention reforms the structure and method for the forming of a polarizer.

One of the objectives of the present invention is to provide a diffusing adhesive layer. The diffusing adhesive layer can improve optical uniformity of a polarizer and brightness contrast and viewable angle of a device.

It is another one of the objectives of the present invention to provide a diffusing adhesive layer comprising uniformly dispersed nano particles so the incident light is uniformly dispersed and spread.

It is another one of objectives of the present invention to provide a polarizer structure. It provides a diffusing adhesive layer that is optically penetrable. Then it provides a polarizer structure that has a high rate of penetration.

It is another one of the objectives of the present invention to provide a method for forming a polarizer. The method has characters of an easier process with a lighter weight. It can reduce the volume that a polarizer occupies in a display device and effectively reduce the cost of manufacturing.

According to the above-mentioned objects of the present invention provides a polarizer structure and a method for forming a polarizer. The method comprises providing a polarizer. The polarizer comprises a polarizing layer. The polarizing layer comprises a PVA film. Then a diffusing adhesive layer is formed above the polarizing layer and a semi-transparent layer is formed below the polarizing layer. Then a plurality of nano particles and a solution are added to a resin to form the diffusing adhesive layer. The plurality of nano particles is organic or inorganic. The method for forming a diffusing adhesive layer above the polarizing layer is to coat the polarizing layer's top surface with the diffusing adhesive layer. Then a plurality of nano particles and a solution are added to a resin to form the semi-transparent layer. Therefore an adherent semi-transparent layer is formed below the polarizing layer's surface. Then a procedure of solidification in the diffusing adhesive layer and the semi-transparent layer is performed. So the solution is removed and the diffusing adhesive layer and the semi-transparent layer acquire better adherence.

The objectives and the advantages of the present invention are expressed by the following writings of embodiments and drawings.

### BRIEF DESCRIPTION OF THE DRAWINGS

The objectives, features of the present invention as well as the advantages thereof can be best understood through the following preferred embodiments and the accompanying drawings, wherein:

FIG. 1A shows a cross section view of a conventional polarizer structure;

FIG. 1B shows a diagram of quantities in distribution and distribution size of particles in a conventional semi-transparent layer;

FIG. 1C shows an intensity diagram of light penetrating a conventional semi-transparent layer;

FIG. 2A shows a step flow diagram of an embodiment of a method for forming a polarizer according to the present invention;

FIG. 2B shows a cross sectional view of a polarizer structure of an embodiment according to the present invention;

FIG. 2C shows a cross sectional of a polarizer structure applied in a display device according to the present invention.

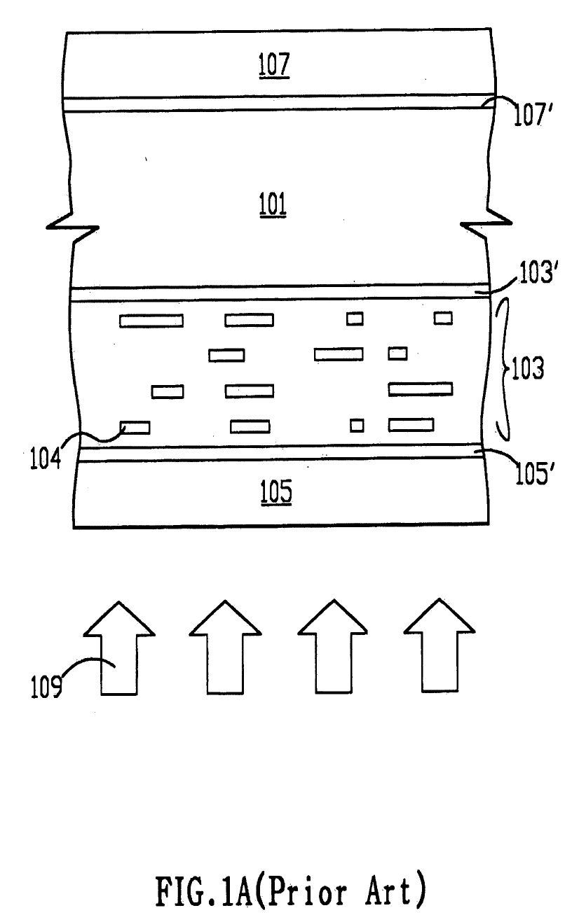

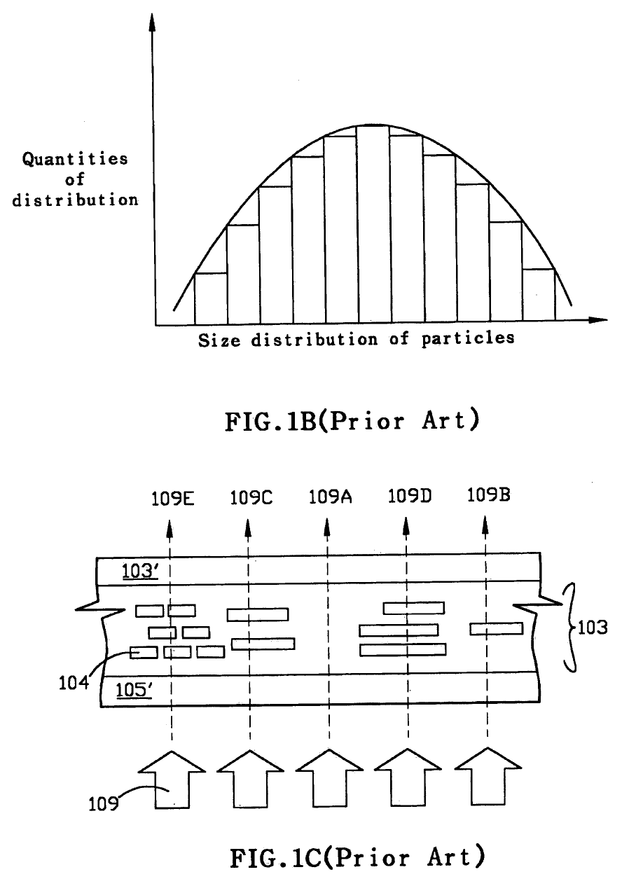

### DESCRIPTION OF THE PREFERRED EMBODIMENT

The present invention provides a structure and a method for forming a polarizer. A diffusing adhesive layer that has optical characters of penetration is formed above a polarizing layer. The diffusing adhesive layer contains a plurality of nano particles. A semi-transparent layer that contains semi-transparent particles is formed below the polarizing layer. A plurality of the uniformly dispersed nono particles and an adherent resin are added in the diffusing adhesive layer. A plurality of nano particles and the resin have optical characters of penetration and a different refraction coefficient. So an incident light can penetrate and be uniformly dispersed and diffused.

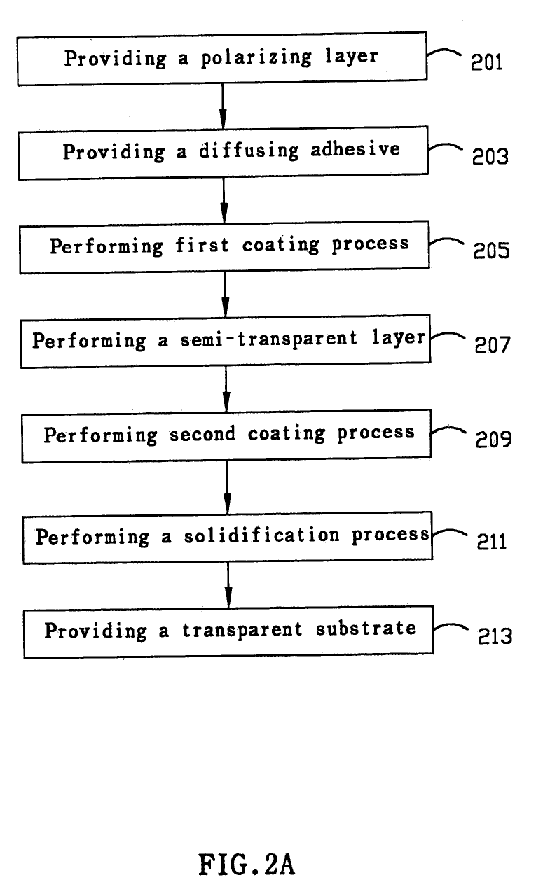

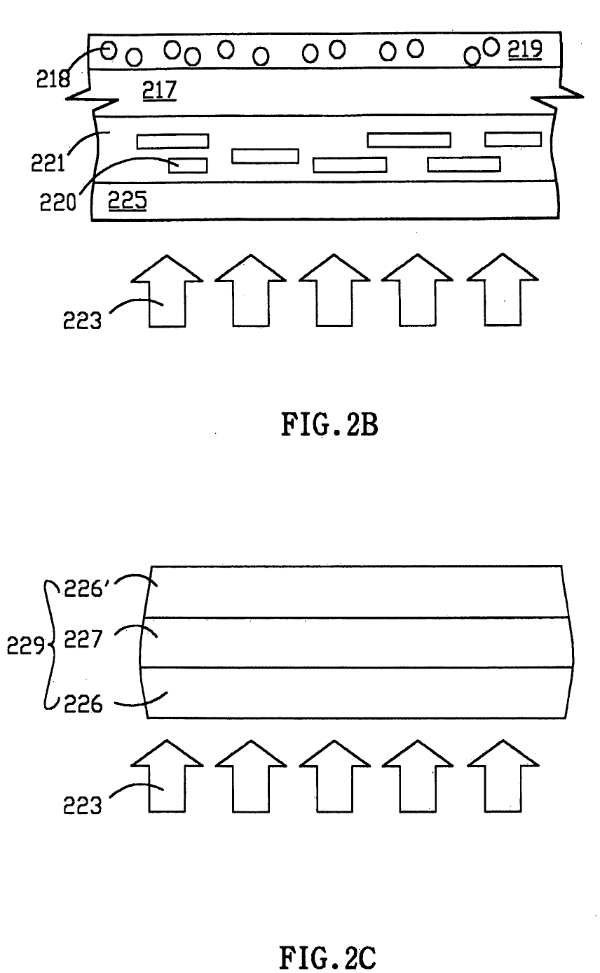

FIG. 2A shows a flow char of the method for forming a polarizer and FIG. 2B shows a cross section view of a polarizer structure according to the better embodiments of the present invention. The objectives and advantages of the present invention are detailed and expressed as follows.

Referring to FIG. 2A, a polarizing layer has a thickness of several ten micrometers that is provided (step 201). The polarizing layer is made of macromolecular substance like PVA film. A plurality of dichroic substances like Iodine ions (I₃⁻ and I₅⁻) or die molecules is added into macromolecular film by osmosis. Moreover, the triacetate fiber layers are formed above and below the macromolecular layer's surface. The triacetate fiber layers can support and protect the macromolecular layer and prevent the macromolecular layer from the wet and high temperature outside.

Then a diffusing adhesive layer is formed above the polarizing layer. The diffusing adhesive layer is about 20 to 40 micrometers of depth. A plurality of nano particles and a resin have an optical penetrability that is uniformly mixed to make a solution. The diffusing adhesive layer is made from the solution. A plurality of nano particles and the resin have different refraction coefficient. The plurality of nano particles is uniformly and randomly dispersed in the diffusing adhesive layer. When the incident light penetrates the polarizer of the present invention, the incident light can be effectively diffused, thus the optical uniformity of a polarizer can be improved. Moreover, the plurality of nano particles and the resin have an optical penetrability. When a light penetrates the diffusing adhesive layer of the present invention, the rate of light penetration is not affected. So the polarizer structure has high rate of penetration.

The plurality of nano particles in the diffusing adhesive layer is made from organic or inorganic materials. The inorganic materials can be SiO₂, TiO₂, silica, alumina, indium oxide, Poly Mtheyl Methacrylate (PMMA) or glass beads. The organic material can be different kinds of cross-linkage macromolecules or non-crosslinkage macromolecules like polethylene, polymethacrtlate, polyvinyl chloride resin or resin styrene. Moreover the solution that is contained by the diffusing adhesive layer can be toluene, ethyl acetate (EA), methyl ethyl ketone, ketone, ester or Alcohol. The resin can be acrylic resin, polyurethane (PU) or polysilica acid (PSA). After the solution mixing with the resin, the diffusing adhesive layer has a proper adherence.

Referring to FIG. 2A, the diffusing adhesive layer is coated above the polarizing layer's surface by performing the first coating process (step 205). The first coating process can be a die coating. Then providing a semi-transparent layer, a resin, a plurality of semi-transparent particles and a solution are uniformly mixed to make the semi-transparent layer. The semi-transparent particles can be in mica. The resin can be perspex, polycarbonate, polyester or polyurethane. The solution can be toluene, ethyl acetate (EA), methyl ethyl ketone, ester, ketone or Alcohol. The solution and the resin are mixed to make the semi-transparent layer. So the semi-transparent layer has proper adherence.

Then, performing the second coating process to the semi-transparent layer (step 209) like sanding, micro-gravure coating or a web tension coating, the semi-transparent layer is coated below the polarizing layer's surface. Afterward performing a solidification process (step 211), for example, performing a thermocuring 2 minutes at 100° C., the solution in the semi-transparent layer and the diffusing adhesive layer is removed. So the diffusing adhesive layer and the semi-transparent layer have adherence. After the thermocuring, the semi-transparent layer, the diffusing adhesive layer and the polarizing layer are merged into a single whole. The diffusing adhesive layer and the semi-transparent layer have better adherence than before solidification, and their adhesion coefficient is about 800 to 2500. Additionally, the diffusing adhesive layer has a glass transition temperature (Tg). The glass transition temperature is about 30° C. to 100° C. Then a transparent substrate like polyester (ET) is provided below the semi-transparent layer. Therefore the polarizer of the present invention is protected.

According to the above-mentioned, the polarizer of the present invention has better optical characters and the adherence of the semi-transparent layer and an adhesive property near solidification is used. In a conventional polarizer, the semi-transparent layer and the polarizing layer are bound by adhesive. But the present invention can omit that. And the diffusing adhesive layer need not use other adhesive materials to bind the polarizing layer. So the adhesive materials and manufacturing time can be saved, thus reducing the cost of manufacturing.

Then referring to FIG. 2B, it shows a cross sectional view of a polarizer structure according to the present invention. The polarizer comprises a transparent substrate 225 and a polarizing layer 217. A diffusing adhesive layer 219 comprising a plurality of nano particles 218 is formed above the surface of the polarizing layer 217, and a semi-transparent layer 221 comprising a plurality of semi-transparent particles 220 is formed below the surface of the polarizing layer 217. When an incident light 223 penetrates the diffusing adhesive layer 219 of the present invention, the nano particles 218 and the resin have different refraction coefficient and are uniformly dispersed in the diffusing adhesive layer. The incident light 223 refracts and reflexes repeatedly in the surfaces of the nano particles 218 to make the light scattering. Therefore the incident light 223 can be dispersed effectively and make the polarizer structure of the present invention has better optical uniformity.

Additionally, the nano particles 218 and the resin have an optical penetrability. When the incident light 223 penetrates the diffusing adhesive layer, the rate of penetration of the light 223 is not affected. The intensity of the incident light is probably equal to the emergent light, and the polarizer structure of the present invention has a high rate of penetration. Additionally, the diffusing adhesive layer 219 and the semi-transparent layer 221 of the present invention have adhesive property. Unlike the prior art, the present invention needs no additional adhesive or other films for binding, therefore time and cost of manufacturing can be saved.

Moreover, the polarizer structure of the present invention is applied to a display device. When an incident light penetrates the polarizer of the present invention, the light is dispersed uniformly. So the brightness contrast and viewable angle of a display device can be improved. Referring to FIG. 2C, a display device like a liquid crystal cell is provided. The display device comprises a liquid crystal cell 227 with a plurality of crystal molecules, and an incident light 223, an upper polarizer 226′ above the liquid crystal cell 227 and a lower polarizer 226 below the liquid crystal cell 227. The upper polarizer 226 is on the side of the liquid crystal cell 227. Additionally, the liquid crystal cell 227, the upper polarizer 226′ and the lower polarizer 226 can be merged into a liquid crystal panel 229 of the display device. The polarizer structure of the present invention can be put in an upper polarizer 226′ or lower polarizer 226. But the polarizer structure located in lower polarizer 226 has a better optical characteristic than the lower polarizer 226′ does. When the upper polarizer 226′ and the lower polarizer 226 use the polarizing structure of the present invention, the brightness, contrast and viewable angle of the display device can be improved.

The upper polarizer 226′ and the lower polarizer 226 are in the liquid crystal panel 229. The upper polarizer 226′ and the lower polarizer 226 comprise an optical uniform diffusing adhesive layer (not shown in FIG. 2C). The diffusing adhesive layer comprises a plurality of nano particles and a resin. The nano particles and the resin have a different refraction coefficient. When the incident light 223 penetrates the liquid crystal panel 229, the incident light 223 can be uniformly dispersed and penetrate the liquid crystal panel 229 entirely. The colors that the display devices show approach white because of the high rate of penetration and high optical uniformity. Therefore brightness and contrast of the words and background and the viewable angle of the display device can be improved.

The above-mentioned preferred embodiments of the present invention are just for example, not limits. Thus, many variations and modifications of the embodiments made without departing form the spirit of the present invention should be covered by the following claims.

What is claimed is:

1. A method for forming a polarizer with the uniform optical property, comprising:
providing a polarizing layer; and
forming a diffusing adhesive layer on a upper surface of said polarizing layer, wherein said diffusing adhesive layer has a plurality of nano particles and a resin, which dispersed an incident light source uniformly.

2. The method of claim 1, wherein said plurality of nano particles and said resin have different refraction coefficient.

3. The method of claim 1, wherein the adhesion coefficient of said diffusing adhesive layer is 800-2500.

4. The method of claim 1, wherein said diffusing adhesive layer is formed by a solution that is mixed said plurality of nano particles with said resin.

5. The method of claim 4, further comprising curing to remove said solution and said diffusing adhesive layer has adhesive property.

6. The method of claim 1, wherein said plurality of nano particles is selected from the group consisting of TiO₂, ZnO and SiO₂.

7. The method of claim 1, wherein said plurality of nano particles is selected from the group consisting of polymethyl methacrylate, styrene resin and polyvinyl chloride resin.

8. The method of claim 4, wherein said resin is selected from the group consisting of polyurethane, polymethyl methacrylate and polysilica acid.

9. The method of claim 4, wherein said solution is toluene.

10. The method of claim 4, wherein said solution is ethyl acetate.

11. The method of claim 4, wherein said solution is methyl ethyl ketone.

12. The method of claim 1, further comprising a semi-transparent layer is formed below said polarizing layer.

13. The method of claim 12, further comprising a thermocuring process is performed after forming said semi-transparent layer, and said semi-transparent layer has adhesive property.

14. The method of claim 12, further comprising a transparent substrate is formed below said semi-transparent layer.

15. A polarizer structure with the uniform optical property, comprising:
a polarizing layer;
a diffusing adhesive layer above a surface of said polarizing layer, said diffusing adhesive layer has adhesive property and having a plurality of nano particles and a resin; and
a semi-transparent layer below the under surface of said polarizing layer, said semi-transparent layer has adhesive property.

16. The polarizer structure with the uniform optical property of claim 15, wherein said plurality of nano particles and said resin have different refraction coefficient.

17. The polarizer structure with the uniform optical property of claim 15, wherein the adhesion coefficient of said diffusing adhesive layer is 800-2500.

18. The polarizer structure with the uniform optical property of claim 15, wherein said plurality of nano particles is selected from the group consisting of TiO₂, ZnO and SiO₂.

19. The polarizer structure with the uniform optical property of claim 15, wherein said nano particles is selected from the group consisting of polymethyl methacrylate, styrene resin and polyvinyl chloride resin.

20. The polarizer structure with the uniform optical property of claim 15, wherein said semi-transparent layer comprises a plurality of semi-transparent particles.

21. The polarizer structure with the uniform optical property of claim 15, further comprising a transparent substrate is adhered directly below said under surface of said semi-transparent layer.

22. A polarizer structure for enhancing the contrast and the viewable angle of a display device, comprising:
a polarizing layer;
a diffusing adhesive layer is above said polarizing layer to form a polarizer structure, wherein said diffusing adhesive layer has adhesive property and having a plurality of nano particles and a resin; and
said polarizer structure is positioned in a display device to increase the contrast and the viewable angle of a display device.

23. The polarizer structure for enhancing the contrast and the viewable angle of a display device of claim 22, wherein said plurality of nano particles and said resin have different refraction coefficient.

24. The polarizer structure for enhancing the contrast and the viewable angle of a display device of claim 22, wherein said plurality of nano particles is selected from the group consisting of TiO₂, ZnO and SiO₂.

25. The polarizer structure for enhancing the contrast and the viewable angle of a display device of claim 22, wherein said plurality of nano particles is selected from the group consisting of polymethyl methacrylate, styrene resin and polyvinyl chloride resin.

26. The polarizer structure for enhancing the contrast and the viewable angle of a display device of claim 22, wherein a semi-transparent layer is adhered below said under surface of said polarizing layer.

27. The polarizer structure for enhancing the contrast and the viewable angle of a display device of claim 26, wherein a transparent substrate is adhered below said under surface of said semi-transparent layer.

28. The polarizer structure for enhancing the contrast and the viewable angle of a display device of claim 26, wherein the adhesion coefficient of said diffusing adhesive layer is 800-2500.
